(19) United States
(12) Patent Application Publication
(10) Pub. No.: US 2025/0058536 A1
(43) Pub. Date: Feb. 20, 2025

(54) TWO-STAGE FEEDING SYSTEM, TWO-STAGE BUILDING MACHINE, UNI-STAGE BUILDING MACHINE, AND FEEDING METHOD

(71) Applicants: MESNAC CO., LTD., Qingdao, SHANDONG PROVINCE (CN); QINGDAO MESNAC MACHINERY& ELECTRIC ENGINEERING CO., LTD., Qingdao, SHANDONG PROVINCE (CN)

(72) Inventors: HUILI YANG, QINGDAO, SHANDONG PROVINCE (CN); ZHIBIN LIU, QINGDAO, SHANDONG PROVINCE (CN); DONGYUN HOU, QINGDAO, SHANDONG PROVINCE (CN); KUN QI, QINGDAO, SHANDONG PROVINCE (CN)

(21) Appl. No.: 18/723,450

(22) PCT Filed: Dec. 22, 2022
(86) PCT No.: PCT/CN2022/141174

§ 371 Date: Jun. 23, 2024

(30) Foreign Application Priority Data
Dec. 22, 2021 (CN) 202111583711.2

(51) Int. Cl. B29D 30/30; B29D 30/20; B29D 30/24

(52) U.S. Cl. CPC B29D 30/30; B29D 30/242; B29D 2030/204

(57) ABSTRACT

Disclosed are a two-stage feeding system, a two-stage forming machine, a unistage forming machine and a feeding method, wherein in the two-stage feeding system, the control device firstly controls the laminating drum to operate to a first pre-set position, when the laminating drum moves to a first pre-set position, the control device controls the first belt layer conveying template to move in a direction close to the laminating drum so as to laminate the first belt layer onto the laminating drum, then the control device further controls the movement of the second belt layer conveying template in the direction close to the laminating drum so as to laminate the second belt layer onto the laminating drum; finally, the control device controls the operation of the laminating drum to a second pre-set position, and when the laminating drum operates to the second pre-set position, the control device controls the movement of the tread conveying template in a direction close to the laminating drum so as to laminate the tread onto the laminating drum. In the system, the belt drum is not deformed in the vertical direction due to the large inertia force, thereby effectively improving the bonding quality of the green tire.

### CROSS-REFERENCE TO RELATED APPLICATION

The present invention claims priority to and the benefit of Chinese Patent Application No. 202111583711.2, filed to the China National Intellectual Property Administration (CNIPA) on Dec. 22, 2021, which is hereby incorporated by reference in its entirety.

### TECHNICAL FIELD

The present application relates to the technical field of tire molding, and in particular, to a two-stage feeding system, a two-stage molding machine, a one-shot molding machine and a feeding method.

### BACKGROUND TECHNOLOGY

A radial tire forming unistage forming machine, which is a mechanical device for forming a raw tire before vulcanization by placing a cylindrical green tire blank produced by a unistage forming machine on a shaping drum of a two-step forming machine, combining the cylindrical green tire blank with components made of a belt layer, a crown belt layer, a tread and the like and completed on a laminating drum of the two-step forming machine, and after the green tire blank is inflated, subjected to pre-shaping, and subjected to shaping and rolling. The two-stage forming machine is mainly composed of a machine frame and a two-stage feeding system, etc., wherein the two-stage feeding system is mainly composed of a laminating drum, a belt-layer front conveying template, a belt-layer rear conveying template, a tread-layer front conveying template and a tread-layer rear conveying template, and the main functions of the two-stage feeding frame are the conveying of the belt layer and the tread, length-determining cutting and the laminating of the laminating drum.

When the bonding drum of the existing two-stage molding machine is bonding the belt layer and the tread, the front template of the belt layer and the front template of the tread are both fixed, and the horizontal movement and the vertical movement are performed by the bonding drum, so as to align the front template of the belt layer and the front template of the tread respectively, and finally, the bonding between the belt layer and the tread is achieved. During the vertical movement of the laminating drum, a relatively large inertia force is applied to the laminating drum, and the laminating drum is prone to deform, thereby affecting the lamination quality of the green tire.

Therefore, how to improve the bonding quality of the green tire is an urgent technical problem to be solved by those skilled in the art.

### SUMMARY OF THE INVENTION

In view of this, an object of the present application is to provide a two-stage feeding system, which can effectively improve the bonding quality of a tire blank.

Another object of the present disclosure is to provide a two-stage molding machine.

Another object of the present disclosure is to provide a secondary molding machine.

Another object of the present application is to provide a feeding method.

To achieve the above objects, the present disclosure provides the following technical solutions:

A two-stage feeding system, comprising a frame; a laminating drum arranged on the frame; a first belt layer conveying template used for conveying a first belt layer and a second belt layer conveying template used for conveying a second belt layer arranged at one side of the laminating drum; a tread conveying template arranged on the other side of the laminating drum for conveying the tread; and a control device electrically connected to the laminating drum, the first belt layer conveying template, the second belt layer conveying template and the tread conveying template, respectively,
the laminating drum can move in a first direction to switch between a first preset position and a second preset position;
the first belt transport template is disposed below the laminating drum, and the first belt transport template can move in a vertical direction so as to approach or move away from the laminating drum;
the second belt transport template is provided on one side of the bonding surface of the laminating drum and is located above the first belt transport template, and the second belt transport template can move along a second direction so as to approach or move away from the laminating drum; wherein the second direction is perpendicular to the first direction, a central line of the second belt layer delivery template is parallel to a central line of the first belt layer delivery template, and a plane determined by the two is perpendicular to a plane determined by the first direction and the second direction;
the tread conveying template is placed above the laminating drum, and the tread conveying template can move in a vertical direction so as to approach or move away from the laminating drum;
when said laminating drum runs to said first pre-set position, said control device controls said first belt layer delivery template to move in the direction close to said laminating drum so as to laminate said first belt layer onto said laminating drum, and said control device controls said second belt layer delivery template to move in the direction close to said laminating drum so as to laminate said second belt layer onto said laminating drum;
when the laminating drum moves to the second preset position, the control device controls the tread delivery template to move towards the laminating drum so as to laminate the tread onto the laminating drum.

Preferably, the first belt transport template comprises a first belt front transport template and a first belt rear transport template which are in butt joint;
a rear end of the first belt ply front conveying template is rotatably connected to the frame, and a front end of the first belt ply front conveying template is provided with a first pushing device for pushing the first belt ply front conveying template to move in a vertical direction so as to approach or move away from the laminating drum;
the first belt post-transporting mould plate is slidably connected to the frame, and the first belt post-transporting mould plate is capable of sliding along the first direction.

Preferably, the first pushing device comprises a triangular lifting device for pushing the transporting template before the first belt layer to move along the vertical direction, and a first driving device for driving the triangular lifting device to move towards the direction of approaching to or moving away from the laminating drum.

Preferably, the triangular lifting device comprises a bottom plate, the bottom plate is provided with a first inclined plate and a second inclined plate, and the bottom plate, the first inclined plate and the second inclined plate are connected to form a triangle;
a first guide rail disposed on the bottom plate, a length direction of the first guide rail being the same as the second direction;
a first guide rail sliding block disposed on the rack and configured to cooperate with the first guide rail;
a second guide rail disposed on the first sloping plate;
and a second guide rail slide block arranged on the first belt ply front conveying template and used for matching with the second guide rail, wherein the second guide rail slide block can drive the first belt ply front conveying template to slide on the second inclined plate, so that the first belt ply front conveying template can move in the vertical direction to approach or away from the laminating drum.

Preferably, the tire further comprises a first deflection correcting device for correcting the position of the first belt layer, the first deflection correcting device comprising:
a first detecting device disposed on the first belt conveyor template;
a third guide rail sliding block provided on the rear conveying template of said first belt layer,
a third guide rail disposed on the frame and configured to cooperate with the third guide rail slider, wherein the length direction of the third guide rail is the same as the first direction;
a second driving member arranged on said frame for driving said first belt layer and then transporting the template to move along said first direction.

Preferably, the second belt transport template comprises a second belt front transport template and a second belt rear transport template which are butt-jointed;
the second belt ply front conveying template comprises a flat conveying template and an arc-shaped conveying template provided at the front end of the flat conveying template, and the arc-shaped conveying template is used for adhering the second belt ply onto the laminating drum;
the arc-shaped conveying template comprises an arc-shaped conveying template frame and a magnet base provided on the arc-shaped conveying template frame, and the magnet base is provided with a magnet for absorbing the second belt layer.

Preferably, the number of the magnet base is three, and one of the magnet bases is provided with a lead for adjusting the mounting angle of the magnet base.

Preferably, a fourth guide rail sliding block is provided on the front conveying template of the second belt layer, and the sliding direction of the fourth guide rail sliding block is the same as the second direction;
the machine frame is provided with a fourth guide rail for matching with the fourth guide rail slider, the fourth guide rail slider being capable of driving the front conveying template of the second belt layer to slide along the second direction;
the machine frame is further provided with a third driver for driving the second conveying template before the belt layer to slide along the second direction so as to approach or depart from the laminating drum.

Preferably, the air conditioner further comprises a second deviation correcting device for correcting the position of the second belt layer, the second deviation correcting device comprising:
a second detecting device disposed on the second belt ply transport template;
a fifth guide rail slider disposed on the second belt layer rear conveyor template;
a fifth guide rail disposed on the rack and configured to cooperate with the fifth guide rail slider, wherein the length direction of the fifth guide rail is the same as the first direction;
a fourth driving member for moving the conveying template along the first direction after pushing the second belt layer.

Preferably, the tread transfer template comprises a mutually abutting tread front transfer template and tread rear transfer template;
a rear end of the front tread conveying template is rotatably connected to the frame, and a front end of the front tread conveying template is provided with a fifth driving member for driving the front tread conveying template to move in a vertical direction so as to approach or move away from the attaching drum;

The template for rear tire tread transport is slidably attached to the frame, and the direction of sliding of the template for rear tire tread transport is the same as the first direction.

Preferably, the tire further comprises a third deflection correcting device for correcting the position of the tread, the third deflection correcting device comprising:
a third detecting device provided on the pre-tread transfer template;
a sixth rail slider positioned on the trailing tread delivery template;
a sixth guide rail disposed on the rack and configured to cooperate with the sixth guide rail slider, wherein the length direction of the sixth guide rail is the same as the first direction;
a sixth driving member for moving the template in the first direction after pushing the tread.

Preferably, the tire further comprises a first belt automatic feeding template which is arranged behind said first belt layer and used for conveying a template, and a second belt automatic feeding template which is arranged behind said second belt layer and used for conveying a template.

A two-stage forming machine, comprising the two-stage feeding system according to any one of the above items.

Disclosed is a primary molding machine, comprising a two-stage molding machine, wherein the two-stage molding machine is a two-stage molding machine as stated above.

A feeding method, comprising:
S100: controlling the laminating drum to operate to a first preset position;
S200: controlling the first belt layer conveying template to move close to the laminating drum so as to laminate the first belt layer onto the laminating drum;
S300: controlling the second belt layer conveying template to move close to the laminating drum so as to laminate the second belt layer onto the laminating drum;
S400: controlling the laminating drum to operate to a second preset position;
S500: controlling the tread delivery molding plate to move toward the conforming drum to conform the tread to the conforming drum.

It can be seen from the above technical solutions that, in the feeding system disclosed in the embodiments of the present application, when the belt layer and the tread are bonded, the control device firstly controls the operation of the laminating drum to a first pre-set position, and when the laminating drum operates to the first pre-set position, the control device controls the first belt layer conveying template to move in a direction close to the laminating drum so as to laminate the first belt layer onto the laminating drum, then the control device further controls the movement of the second belt layer conveying template in the direction close to the laminating drum so as to laminate the second belt layer onto the laminating drum; finally, the control device controls the operation of the laminating drum to a second pre-set position, and when the laminating drum operates to the second pre-set position, the control device controls the movement of the tread conveying template in a direction close to the laminating drum so as to laminate the tread onto the laminating drum. Compared with the prior art, in the bonding process of the belt layer and the tread, the bonding drum does not move in the vertical direction, and the bonding of the belt layer and the tread can be achieved only by moving in the horizontal direction along the axis direction thereof, and therefore the belt drum is not deformed in the vertical direction due to the large inertia force, thereby effectively improving the bonding quality of the green tire.

### BRIEF DESCRIPTION OF THE DRAWINGS

To describe the technical solutions in the embodiments of the present application or in the prior art more clearly, the following briefly introduces the accompanying drawings required for describing the embodiments or the prior art. Apparently, the accompanying drawings in the following description show merely embodiments of the present application, and a person of ordinary skill in the art may still derive other drawings from the accompanying drawings without creative efforts.

FIG. 1 is a schematic structural side view of an isometric view of a feeding system disclosed in an embodiment of the present application;

FIG. 2 is a schematic structural right view of a feeding system disclosed in an embodiment of the present application;

FIG. 3 is an enlarged structural schematic diagram of a triangular lifting device disclosed in an embodiment of the present application;

FIG. 4 is a schematic structural view of a second conveyor belt in front of a template according to an embodiment of the invention;

FIG. 5 is a schematic structural view of an arc-shaped delivery template according to an embodiment of the present application;

FIG. 6 is a partially enlarged schematic structural view of an arc-shaped conveying template disclosed in an embodiment of the present application;

FIG. 7 is a schematic diagram of a feeding method according to an embodiment of the present application.

The figures include the following reference signs:

100: a machine frame, 101: a first guide rail sliding block, 102: a second guide rail sliding block, 103: a third guide rail, 104: a fourth guide rail, 105: a fifth guide rail, 200: a laminating drum, 300: a first belt layer delivery template, 301: a first belt layer front delivery template, 302: a first belt layer rear conveying die; 303: a first pushing device; 3031: a triangular lifting device; 3031-a: a bottom plate, 3031-a-1: a first guide rail, 3031-b: a first oblique plate, 3031-b-1: a second guide rail, 3031-c: a second oblique plate, 304: a third guide rail sliding block, 307: a first automatic feeding template for a belt layer,
400: a second belt layer conveying template, 401: a second belt layer front conveying template, 4011: a flat and straight conveying template, 4012-a: an arc-shaped conveying template, 4012-a: a magnet seat, 4013: a push wire, 402: a second belt layer rear conveying template, 403: a fourth guide rail sliding block, 404: a fifth guide rail sliding block, 406: a second belt layer automatic feeding template,
500: a tread transfer template, 501: a tread front transfer template, 502: a tread rear transfer template.

### DETAILED DESCRIPTION OF THE EMBODIMENTS

In view of this, the core of the present application is to provide a two-stage feeding system, which can effectively improve the fitting quality of a tire blank.

Another object of the present disclosure is to provide a two-stage molding machine.

Another object of the present disclosure is to provide a secondary molding machine.

Another object of the present application is to provide a feeding method.

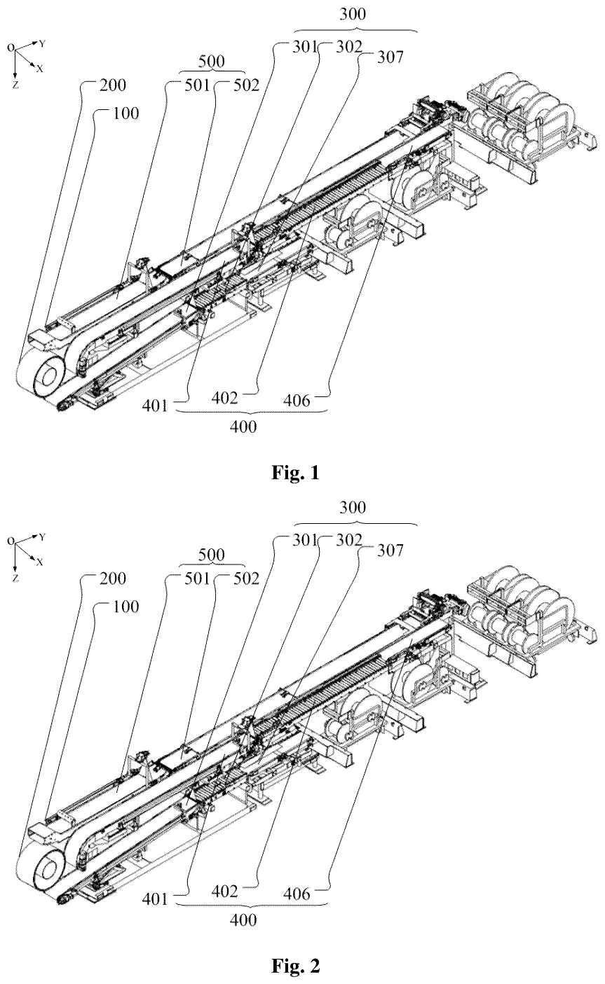

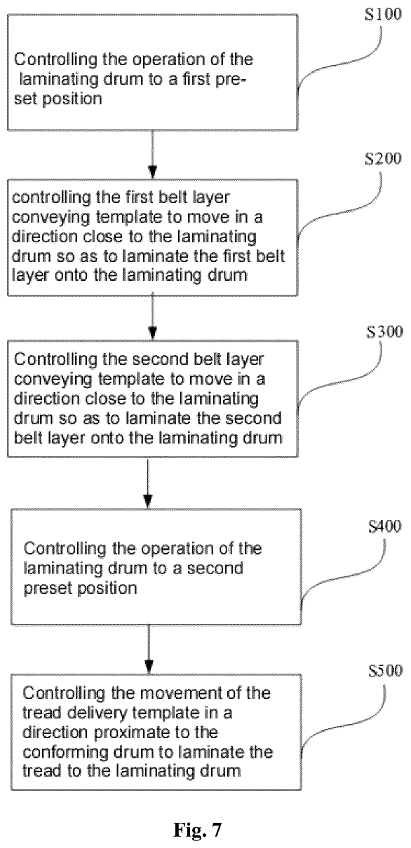

In order to make persons skilled in the art better understand the solutions of the present application, the present application will be further described in detail with reference to FIG. 1 to FIG. 7 in conjunction with the accompanying drawings and specific embodiments.

Please refer to FIGS. 1 to 2, the two-stage feeding system disclosed in the embodiment of the present application comprises a rack 100, a laminating drum 200 arranged on the rack 100; a first belt layer conveying template 300 for conveying a first belt layer and a second belt layer conveying template 400 for conveying a second belt layer which are arranged at one side of the laminating drum 200; a tread conveying template 500 arranged on the other side of the laminating drum 200 for conveying the tread; a control device electrically connected to the laminating drum 200, the first belt layer conveying template 300, the second belt layer conveying template 400 and the tread conveying template 500, respectively, wherein the laminating drum 200 can move in a first direction to switch between a first preset position and a second preset position; the first belt layer conveying template 300 is placed below the laminating drum 200, and the first belt layer conveying template 300 can move in the vertical direction so as to approach or move away from the laminating drum 200; the second belt layer conveying template 400 is arranged on one side of the bonding face of the laminating drum 200 and is located above the first belt layer conveying template 300, and the second belt layer conveying template 400 can move along a second direction so as to approach or depart from the laminating drum 200; wherein the second direction is perpendicular to the first direction, the central line of the second belt layer conveying template 400 is parallel to the central line of the first belt layer conveying template 300, and a plane determined by the two is perpendicular to a plane determined by the first direction and the second direction; The tread conveying mold plate 500 is placed above the laminating drum 200, and the tread conveying mold plate 500 can move in a vertical direction so as to approach or move away from the laminating drum 200.

when the belt layer and the tread are bonded together, the control device firstly controls the operation of the bonding drum 200 to a first pre-set position, when the laminating drum 200 runs to a first pre-set position, the control device controls the first belt layer conveying template 300 to move in a direction close to the laminating drum 200 so as to laminate the first belt layer onto the laminating drum 200, then the control device further controls the movement of the second belt layer conveying template 400 in the direction close to the laminating drum 200 so as to laminate the second belt layer onto the laminating drum 200; finally, the control device controls the operation of the laminating drum 200 to a second pre-set position, and when the laminating drum 200 operates to the second pre-set position, the control device controls the movement of the tread conveying template 500 in a direction close to the laminating drum 200 so as to laminate the tread onto the laminating drum 200. Compared with the prior art, in the bonding process of the belt layer and the tread, the bonding drum 200 does not move in the vertical direction, and the bonding of the belt layer and the tread can be achieved merely by moving in the horizontal direction along the axis direction thereof; therefore, the belt drum does not deform the bonding drum 200 in the vertical direction due to the large inertia force applied thereto, thereby effectively improving the bonding quality of the green tire.

It is to be explained that the first direction is the direction OX and the second direction is the direction OY.

Please refer to FIG. 2, the first belt transport template 300 disclosed in the embodiment of the present application comprises a first belt front transport template 301 and a first belt rear transport template 302 connected to each other, wherein the rear end of the first belt ply front conveying template 301 is rotatably connected to the frame 100, and the front end of the first belt ply front conveying template 301 is provided with a structure for pushing the first belt ply front conveying template 301 to move in the vertical direction, With the first pushing device moving closer to or away from the laminating drum 200, the first pushing device can be activated to push the first conveying template 301 to move in the vertical direction so as to move closer to or away from the laminating drum 200.

It should be noted that, the rear end of the first conveying template for the front belt layer 301 is connected to a seat bearing through a rotating shaft, the seat bearing is fixed on the transition plate through a screw, and the transition plate is fixed on the frame 100 through the screw; therefore, the first conveying template for the front belt layer 301 can be coaxially and vertically swung through the seat bearing.

It is understood that the smaller the gap between the first belt ply front conveying mold plate 301 and the first belt ply rear conveying mold plate 302 is, the more favorable the smooth transmission of the first belt ply is.

It should be further noted that the first belt layer rear conveying mold plate 302 is slidably connected to the frame 100, and the first belt layer rear conveying mold plate 302 can slide in the first direction.

The specific structure of the first pushing device is not limited in the embodiments of the present application. The first pushing device can be directly driven by an air cylinder, can be directly driven by an electric cylinder, and can also be directly driven by a linear motor. All the structures satisfying the usage requirements of the present application belong to the scope of protection of the present application.

In order to make the operation of the first conveying template 301 ahead of the belt layer more stable and the operation of the whole feeding system more reliable, the first pushing device disclosed in the embodiment of the present application comprises a triangular lifting device 3031 for pushing the first conveying template 301 ahead of the belt layer to move along the vertical direction, and a first driving member for driving the triangular lifting device 3031 to move towards the direction of approaching to or moving away from the laminating drum 200.

The specific structure of the first drive member is not limited in the embodiments of the present application. The first drive member may be a cylinder or an electric cylinder. All structures satisfying the use requirements of the present application belong to the scope of protection of the present application. For convenient installation and arrangement, the embodiments of the present application preferably use an electric cylinder. A cylinder seat of the electric cylinder is disposed on a rack 100, and a telescopic rod of the electric cylinder is disposed on a triangular lifting device 3031.

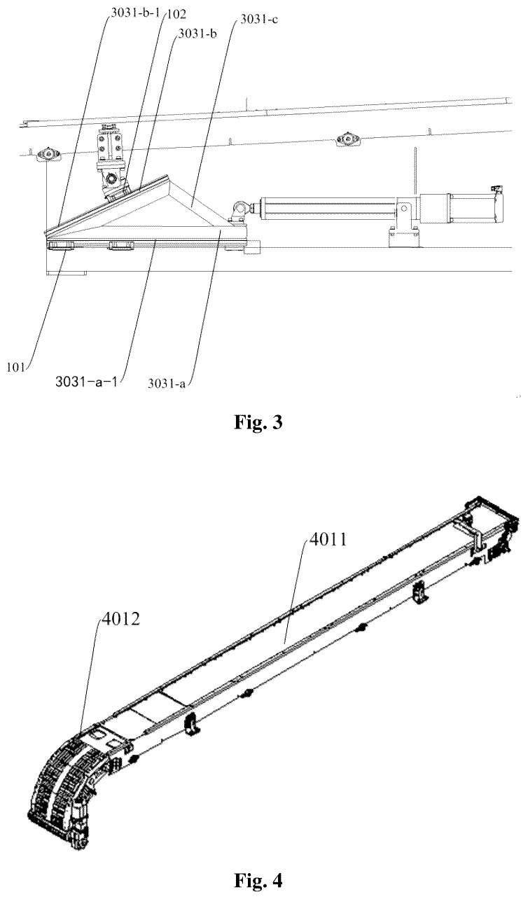

Please refer to FIG. 3, in order to further optimize the foregoing embodiment, the triangular lifting device 3031 disclosed in the embodiment of the present application includes a bottom plate 3031-a, a first sloping plate 3031-b and a second sloping plate 3031-c are provided on the bottom plate 3031-a, and the bottom plate 3031-a, the first sloping plate 3031-b and the second sloping plate 3031-c are connected to form a triangle, A first guide rail sliding block 101 is disposed on the bottom plate 3031-a, and a length direction of the first guide rail 3031-a-1 is the same as a second direction, a first guide rail sliding block 101 used for mating with a first guide rail 3031-a-1 is arranged on the rack 100, and a second guide rail 3031-b-1 is arranged on a first sloping plate 3031-b, a second guide rail sliding block 102 used for mating with a second guide rail 3031-b-1 is provided on the first belt front conveying template 301, The second guide rail sliding block 102 can drive the first conveying template 301 of the front belt layer to slide on the second sloping plate 3031-c, so that the first belt ply front conveying template 301 can move in the vertical direction to approach or move away from the laminating drum 200. With this arrangement, the triangular-lift device 3031 can move in a second direction toward or away from the laminating drum 200 with the engagement of the first rail slider 101 and the first guide rails 3031-a-1. When the cylinder is started and the telescopic rod of the cylinder is extended, the triangular lifting device 3031 is pushed to move towards the direction close to the laminating drum 200, At this time, the second guide rail sliding block 102 slides from bottom to top along the inclined surface of the first sloping plate 3031-b, and drives the front conveying template 301 of the first belt layer to move upwards, on the contrary, the telescopic rod of the electric cylinder retracts to drive the triangular lifting device 3031 to move in a direction away from the attaching drum 200, At this time, the second guide rail sliding block 102 drives the first conveying template 301 of the front belt layer to slide from top to bottom along the inclined surface of the first sloping plate 3031-b, driving the first belt layer front conveying template 301 to achieve a descending movement.

In order to ensure the bonding quality of the first belt layer, the feeding system disclosed in the embodiments of the present application further comprises a first deflection correcting device for correcting the position of the first belt layer, wherein the first deflection correcting device comprises a deflection correcting lens arranged on the first belt layer conveying template 300; a third guide rail sliding block 304 arranged on the first belt layer rear conveying template 302, and a third guide rail arranged on the frame 100 and used for cooperating with the third guide rail sliding block 304, wherein the length direction of the third guide rail is the same as the first direction; and a second driving member arranged on the frame 100 for driving the first belt layer and then moving the conveying template 302 along the first direction.

It should be noted that, the specific structure of the first driving member is not limited in the embodiments of the present application, and the first driving member may be a cylinder, may also be an electric cylinder, as long as the structure satisfying the usage requirements of the present application belongs to the scope of protection of the present application, In order to facilitate installation and arrangement, the embodiment of the present application preferably uses an electric cylinder, and a cylinder seat of the electric cylinder is arranged on the rack 100, A telescopic rod of a cylinder is provided on one side of the first belt layer rear conveying mold plate 302.

during the conveying of the first belt layer, a first detection device detects the position of the first belt layer on a conveying template 302 after the first belt layer, and judging whether the first belt layer is offset on the conveying template 302 after the first belt layer, and transmitting a signal to a control device, the control device controls a cylinder rod of the cylinder to extend or retract, and drives the first belt layer and then the conveying template 302 to horizontally swing along a first direction, Thus, the deflection of the first belt layer can be obtained.

Please refer to FIG. 4, in the feeding system disclosed in the embodiment of the present application, the second belt layer delivery template 400 comprises a second belt layer front delivery template 401 and a second belt layer rear delivery template 402 which are butt-jointed; The second belt ply front conveying template 401 comprises a flat conveying template 4011 and an arc-shaped conveying template 4012 arranged at the front end of the flat conveying template 4011 and used for bonding the second belt ply onto the bonding drum 200, in which the arc-shaped conveying template 4012 comprises an arc-shaped conveying template frame and a magnet base 4012-a arranged on the arc-shaped conveying template frame, and the magnet base 4012-a is provided with a magnet for attracting the second belt ply.

The second belt layer is first transported from the second belt transporting template 402 to the flat transporting template 4011 on the second belt transporting template 401, then transported from the flat transporting template 4011 on the second belt transporting template 401 to the arc-shaped transporting template 4012, and finally the second belt layer is bonded to the laminating drum 200 by the arc-shaped transporting template 4012.

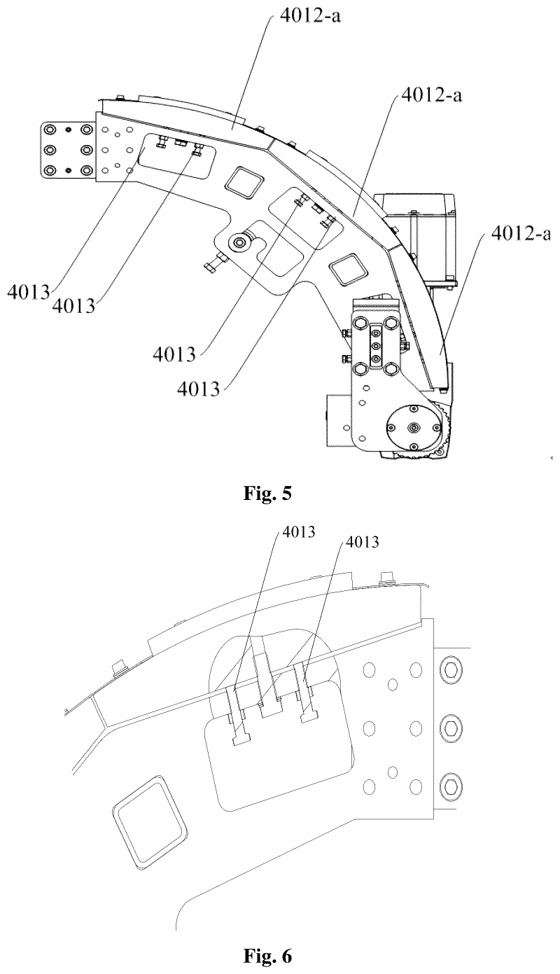

Please refer to FIG. 5 to FIG. 6, three magnet holders 4012-a are disclosed in the embodiments of the present application, and a lead wire 4013 for adjusting an installation angle of the magnet holder 4012-a is disposed on any one of the magnet holders 4012-a. The lead wires 4013 are respectively provided at two sides of the magnet base 4012-a, and the height, angle and the like of the magnet base 4012-a can be adjusted by adjusting the lead wires 4013, so that the second belt layer can be better attached to the laminating drum 200.

Since both the first belt layer and the second belt layer are provided with steel cords, the second belt layer may be adsorbed onto the arc conveying mold plate 4012 by a magnet, so as to facilitate the attachment of the second belt layer to the laminating drum 200.

It should be noted that the conveyor belt is provided on the second belt conveyor mould plate, and a driving wheel for driving the conveyor belt is further provided below the arc-shaped conveyor mould plate frame, in which the driving wheel is connected to a motor, and drives the driving wheel to rotate by starting the motor, and the driving wheel drives the conveyor belt to move, thereby conveying the second belt layer.

Please refer to FIG. 2, the second belt ply front conveying template 401 is slidably connected to the frame 100, and the sliding direction of the second belt ply front conveying template 401 is the same as the conveying direction of the second belt ply.

In order to further optimize the described embodiments, a fourth guide rail sliding block 403 is provided on the second belt layer front conveying template 401, and the sliding direction of the fourth guide rail sliding block 403 is the same as the second direction; the frame 100 is provided with a fourth guide rail 104 for matching with a fourth guide rail slider 403, and the fourth guide rail slider 403 can drive the second belt layer front conveying template 401 to slide along a second direction; The frame 100 is provided with a third driver for driving the second belt ply front conveying mold plate 401 to slide in the second direction so as to approach or move away from the laminating drum 200.

It should be noted that, the embodiment of the present application does not limit the specific structure of the third driving member, and the third driving member may be a cylinder, may also be an electric cylinder, as long as the structure satisfying the usage requirements of the present application belongs to the scope of protection of the present application, In order to facilitate installation and arrangement, the embodiment of the present application preferably uses an electric cylinder, and a cylinder seat of the electric cylinder is arranged on the rack 100, A telescopic rod of a cylinder is provided on the second belt ply front conveying mold plate 401. when the cylinder is started, a telescopic rod of the cylinder extends out, and under the cooperation of the fourth guide rail sliding block 403 and the fourth guide rail 104, the conveying template 401 is pushed to move along the fourth guide rail 104 in a direction close to the laminating drum 200; When the cylinder is closed, the telescopic rod of the cylinder retracts, and under the cooperation of the fourth guide rail sliding block 403 and the fourth guide rail 104, the front conveying template 401 of the second belt layer is driven to move along the fourth guide rail 104 in a direction away from the laminating drum 200.

In order to further optimize the described embodiments, the feeding system disclosed in the embodiments of the present application further comprises a second deflection correcting device for correcting the second belt layer, wherein the second deflection correcting device comprises a second deflection correcting detection device arranged on the second belt layer conveyance template 400; a fifth guide rail sliding block 404 arranged on the second belt layer rear conveying template 402; a fifth guide rail 105 arranged on the frame 100 and used for cooperating with the fifth guide rail sliding block 404, and the length direction of the fifth guide rail 105 being the same as the first direction; a fourth driver for pushing the second belt ply front conveying template 401 to move along the first direction.

It should be noted that, the embodiment of the present application does not limit the specific structure of the fourth driving member, and the fourth driving member may be a cylinder, may also be an electric cylinder, as long as the structure satisfying the usage requirements of the present application belongs to the scope of protection of the present application, In order to facilitate installation and arrangement, the embodiment of the present application preferably uses an electric cylinder, and a cylinder seat of the electric cylinder is arranged on the rack 100, a telescopic rod of a cylinder is provided on one side of the second belt layer rear transporting template 402.

During transport of the second belt ply, a second detection device detects the position of the second belt ply on the second belt ply rear transport template 402, and judging whether the second belt layer is offset on the conveying template 402 after the second belt layer, and transmitting a signal to a control device, the control device controls a cylinder rod of the cylinder to extend or retract, and drives the second belt layer to horizontally swing the conveying template 402 along a first direction, Thus, the second belt layer can be corrected.

With continued reference to FIG. 1, in the feeding system disclosed in the embodiment of the present application, the tread conveying template 500 comprises a front tread conveying template 501 and a back tread conveying template 502; The rear end of the front tread conveying template 501 is rotatably connected to the rack 100, and the front end of the front tread conveying template 501 is provided with a fifth driving member for driving the front tread conveying template 501 to move in the vertical direction so as to approach or move away from the laminating drum 200. With this arrangement, the front tread transfer mold plate 501 can be driven to move in the vertical direction by activating the fifth actuator to approach or move away from the attachment drum 200.

It should be noted that, the rear end of the tread front conveying template 501 is connected to a seat bearing through a rotating shaft, the seat bearing is fixed on the transition plate through a screw, and the transition plate is fixed on the frame 100 through the screw; therefore, the tread front conveying template 501 can coaxially and vertically swing through the seat bearing.

It is understood that the smaller the gap between the front tread transfer template 501 and the rear tread transfer template 502, the more favorable the smooth transfer of the tread.

It should be further noted that the rear tread transfer mold plate 502 is slidably connected to the chassis 100, and the sliding direction of the rear tread transfer mold plate 502 is the same as the first direction.

The embodiments of the present application do not limit the specific structure of the fifth drive member. The fifth drive member can be directly driven by a cylinder, can be directly driven by an electric cylinder, and can also be directly driven by a linear motor. All the structures satisfying the usage requirements of the present application belong to the scope of protection of the present application.

As a preferred embodiment of the present application, the feeding system disclosed in the embodiments of the present application further comprises a third deflection correcting device for correcting the tread, the third deflection correcting device comprising:
a third detecting device provided on the pre-tread transfer mold plate 501;
a sixth guide rail sliding block provided on the rear tread conveying template 502, and a sixth guide rail provided on the frame 100 and used for cooperating with the sixth guide rail sliding block, wherein the length direction of the sixth guide rail is the same as the first direction; A sixth drive for moving the trailing tread transfer template 502 in a first direction.

It should be noted that, the specific structure of the sixth driving member is not limited in the embodiments of the present application, and may be a cylinder or an electric cylinder; as long as the structure meeting the usage requirements of the present application belongs to the scope of protection of the present application; in order to facilitate installation and arrangement, the embodiments of the present application preferably use an electric cylinder, in which a cylinder seat of the electric cylinder is arranged on the frame 100, and a telescopic rod of the electric cylinder is arranged on one side of the rear tread conveying template 502.

In the process of conveying the tread, a third detection device detects the position of the tread on the rear conveying template 502 of the tread, determines whether the tread is offset on the rear conveying template 502 of the tread, and transmits a signal to a control device; and the control device controls a cylinder rod of a cylinder to extend or retract, so as to drive the rear conveying template 502 of the tread to swing horizontally along a first direction, thereby correcting the deflection of the tread.

It should be noted that the two-stage feeding system disclosed in the embodiment of the present application further comprises a first belt layer automatic feeding template 307 which is arranged behind the first belt layer conveying template 302, and a second belt layer automatic feeding template 406 which is arranged behind the second belt layer conveying template 402.

The above-mentioned first belt layer automatic material-feeding template 307 and second belt layer automatic material-feeding template 40 can automatically transport the rubber materials on the guiding trolley to the belt layer and then transport same, without requiring human disposal.

Also disclosed in the embodiments of the present application is a two-stage forming machine, wherein the two-stage forming machine comprises the two-stage forming machine disclosed in any one of the described embodiments.

Embodiments of the present application further disclose a primary molding machine. The primary molding machine includes the primary molding machine disclosed in any one of the foregoing embodiments.

An embodiment of the present application further discloses a feeding method, comprising: S100: controlling an attachment drum 200 to operate to a first preset position; S200: controlling the first belt layer conveying template 300 to move in a direction close to the laminating drum 200 so as to laminate the first belt layer onto the laminating drum 200; S300: controlling the second belt layer conveying template 400 to move in a direction close to the laminating drum 200 so as to laminate the second belt layer onto the laminating drum 200; S400: controlling the operation of the laminating drum 200 to a second preset position; S500: controlling the movement of the tread conveying template 500 in a direction close to the laminating drum 200 so as to laminate the tread onto the laminating drum 200. when the belt layer and the tread are bonded together, the control device firstly controls the operation of the bonding drum 200 to a first pre-set position, when the laminating drum 200 runs to a first pre-set position, the control device controls the first belt layer conveying template 300 to move in a direction close to the laminating drum 200 so as to laminate the first belt layer onto the laminating drum 200, then the control device further controls the movement of the second belt layer conveying template 400 in the direction close to the laminating drum 200 so as to laminate the second belt layer onto the laminating drum 200; finally, the control device controls the operation of the laminating drum 200 to a second pre-set position, and when the laminating drum 200 operates to the second pre-set position, the control device controls the movement of the tread conveying template 500 in a direction close to the laminating drum 200 so as to laminate the tread onto the laminating drum 200. Compared with the prior art, in the bonding process of the belt layer and the tread, the bonding drum 200 does not move in the vertical direction, and the bonding of the belt layer and the tread can be achieved merely by moving in the horizontal direction along the axis direction thereof; therefore, the belt drum does not deform the bonding drum 200 in the vertical direction due to the large inertia force applied thereto, thereby effectively improving the bonding quality of the green tire.

In the description of the present application, it should be noted that the orientation or position relations indicated by the terms “central”, “upper”, “lower”, “left”, “right”, “vertical”, “horizontal”, “inner”, “outer”, etc. are based on the orientation or position relations shown in the figures, It is only for the convenience of describing the present application and simplifying the description, rather than indicating or implying that the indicated device or element must have a particular orientation, be constructed and operated in a particular orientation, Therefore, it cannot be understood that the present disclosure is limited thereto. In addition, the terms “first”, “second”, and “third” are used for descriptive purposes only and are not to be construed as indicating or implying relative importance.

Unless otherwise specified or limited, the terms “mounted”, “connected”, ‘and “coupled” should be used broadly, and may be, for example, fixed connections, detachable connections, or integral connections; may also be mechanical or electrical connections; may also be direct connections or indirect connections via intervening structures; and may also be inner communications of two elements. The specific meanings of the above terms in the present application can be understood by those skilled in the art according to specific situations.

The above descriptions of the disclosed embodiments enable a person skilled in the art to implement or use the present application. Various modifications to these embodiments will be readily apparent to those skilled in the art. The general principles defined herein may be implemented in other embodiments without departing from the spirit or scope of the present application. Accordingly, the present application will not be limited to the embodiments shown herein but is to be accorded the widest scope consistent with the principles and novel features disclosed herein.

1. A two-stage feeding system, comprising a frame; a laminating drum arranged on the frame; a first belt layer conveying template used for conveying a first belt layer and a second belt layer conveying template used for conveying a second belt layer arranged at one side of the laminating drum; a tread conveying template provided on the other side of the laminating drum for conveying the tread; and a control device electrically connected to the laminating drum, the first belt layer conveying template, the second belt layer conveying template and the tread conveying template, respectively, characterized in that,
the laminating drum can move in a first direction to switch between a first preset position and a second preset position;
the first belt transport template is disposed below the laminating drum, and the first belt transport template can be close to or far away from the laminating drum;
the second belt transport template is provided on one side of the bonding surface of the laminating drum and is located above the first belt transport template, and the second belt transport template can move along a second direction so as to approach or move away from the laminating drum;
the tread conveying template is placed above the laminating drum, and the tread conveying template can be close to or far away from the laminating drum;
when said laminating drum runs to said first pre-set position, said control device controls said first belt layer delivery template to move in the direction close to said laminating drum so as to laminate said first belt layer onto said laminating drum, and said control device controls said second belt layer delivery template to move in the direction close to said laminating drum so as to laminate said second belt layer onto said laminating drum;
when the laminating drum moves to the second preset position, the control device controls the tread delivery template to move towards the laminating drum so as to laminate the tread onto the laminating drum.

2. The two-stage feeding system according to claim 1, characterized in that,
the first belt conveying template can move in a vertical direction so as to approach or move away from the laminating drum;
the second direction is perpendicular to the first direction, a central line of the second belt layer delivery template is parallel to a central line of the first belt layer delivery template, and a plane determined by the two is perpendicular to a plane determined by the first direction and the second direction;
the tread transfer template is movable in a vertical direction to be closer to or further from the bonding drum.

3. The two-stage feeding system according to claim 1, characterized in that,
said first belt transport template comprises a first belt front transport template and a first belt rear transport template which are in butt joint;
a rear end of the first belt ply front conveying template is rotatably connected to the frame, and a front end of the first belt ply front conveying template is provided with a first pushing device for pushing the first belt ply front conveying template to move in a vertical direction so as to approach or move away from the laminating drum;
the first belt post-transporting mould plate is slidably connected to the frame, and the first belt post-transporting mould plate is capable of sliding along the first direction.

4. The two-stage feeding system according to claim 3, characterized in that the first pushing device comprises a triangular lifting device for pushing the transporting template before the first belt layer to move along a vertical direction, and a first driving member for driving the triangular lifting device to move towards or away from the attaching drum.

5. The two-stage feeding system according to claim 4, wherein the triangular lifting device comprises a bottom plate, a first inclined plate and a second inclined plate are provided on the bottom plate, and the bottom plate, the first inclined plate and the second inclined plate are connected to form a triangular shape;
a first guide rail disposed on the bottom plate, a length direction of the first guide rail being the same as the second direction;
a first guide rail sliding block disposed on the rack and configured to cooperate with the first guide rail;
a second guide rail disposed on the first sloping plate; and
a second guide rail slide block arranged on the first belt ply front conveying template and used for matching with the second guide rail, wherein the second guide rail slide block can drive the first belt ply front conveying template to slide on the second inclined plate, so that the first belt ply front conveying template can move in the vertical direction to approach or away from the laminating drum.

6. The two-stage feeding system according to claim 3, further comprising a first deviation correcting device for correcting the position of the first belt layer, wherein the first deviation correcting device comprises:
a first detecting device disposed on the first belt conveyor template;
a third guide rail slide block provided on the rear conveying template of said first belt layer;
a third guide rail disposed on the frame and configured to cooperate with the third guide rail slider, wherein the length direction of the third guide rail is the same as the first direction;
a second driving member arranged on said frame for driving said first belt layer and then transporting the template to move along said first direction.

7. The two-stage feeding system according to claim 1, characterized in that,
the second belt transport template comprises a second belt front transport template and a second belt rear transport template which are in butt joint;
the second belt ply front conveying template comprises a flat conveying template and an arc-shaped conveying template provided at the front end of the flat conveying template, and the arc-shaped conveying template is used for adhering the second belt ply onto the laminating drum;
the arc-shaped conveying template comprises an arc-shaped conveying template frame and a magnet base provided on the arc-shaped conveying template frame, and the magnet base is provided with a magnet for absorbing the second belt layer.

8. The two-stage feeding system according to claim 7, wherein there are three magnet holders, and any one of the magnet holders is provided with a lead for adjusting an installation angle of the magnet holder.

9. The two-stage feeding system according to claim 7, characterized in that,
a fourth guide rail sliding block is provided on the second belt front conveying template, and the sliding direction of the fourth guide rail sliding block is the same as the second direction;
the machine frame is provided with a fourth guide rail for matching with the fourth guide rail slider, the fourth guide rail slider being capable of driving the front conveying template of the second belt layer to slide along the second direction;
the machine frame is further provided with a third driver for driving the second conveying template before the belt layer to slide along the second direction so as to approach or depart from the laminating drum.

10. The two-stage feeding system according to claim 7, further comprising a second deviation correcting device for correcting the position of the second belt layer, wherein the second deviation correcting device comprises:
a second detecting device disposed on the second belt ply transport template;
a fifth guide rail slider disposed on the second belt layer rear conveyor template;
a fifth guide rail disposed on the rack and configured to cooperate with the fifth guide rail slider, wherein the length direction of the fifth guide rail is the same as the first direction;
a fourth driving member for moving the conveying template along the first direction after pushing the second belt layer.

11. The two-stage feeding system according to claim 1, characterized in that,
the tread transfer template comprising a contiguous, leading tread transfer template and a trailing tread transfer template;
a rear end of the front tread conveying template is rotatably connected to the frame, and a front end of the front tread conveying template is provided with a fifth driving member for driving the front tread conveying template to move in a vertical direction so as to approach or move away from the attaching drum;
the template for rear tire tread transport is slidably attached to the frame, and the direction of sliding of the template for rear tire tread transport is the same as the first direction.

12. The two-stage feeding system according to claim 11, further comprising a third deviation correcting device for correcting the position of the tread, wherein the third deviation correcting device comprises:
a third detecting device provided on the pre-tread transfer template;
a sixth rail slider positioned on the trailing tread delivery template;
a sixth guide rail disposed on the rack and configured to cooperate with the sixth guide rail slider, wherein the length direction of the sixth guide rail is the same as the first direction;
a sixth driving member for moving the template in the first direction after pushing the tread.

13. The two-stage feeding system according to claim 1, characterized in further comprising a first belt automatic feeding template which is provided after the first belt layer and transports a template, and a second belt automatic feeding template which is provided after the second belt layer and transports a template.

14. A two-stage forming machine, comprising the two-stage feeding system according to claim 1.

15. A primary molding machine, comprising a two-stage molding machine, wherein the two-stage molding machine is the two-stage molding machine according to claim 14.

16. A feeding method, characterized by comprising:
S100: controlling the laminating drum to operate to a first preset position;
S200: controlling the first belt layer conveying template to move close to the laminating drum so as to laminate the first belt layer onto the laminating drum;
S300: controlling the second belt layer conveying template to move close to the laminating drum so as to laminate the second belt layer onto the laminating drum;
S400: controlling the laminating drum to operate to a second preset position;
S500: controlling the tread delivery molding plate to move in a direction toward the conforming drum to conform the tread to the conforming drum.
